(19) United States
(12) Patent Application Publication
(10) Pub. No.: US 2017/0051152 A1
(43) Pub. Date: Feb. 23, 2017

(54) USE OF COPOLYMERS OF STYRENE AND OF MALEIC ANHYDRIDE FOR PREPARING PARTICLES OF MINERAL MATTER

(71) Applicant: COATEX, Genay (FR)

(72) Inventors: Jacques MONGOIN, Quincieux (FR); Christian JACQUEMET, Lyon (FR); Jean-Marc SUAU, Lucenay (FR)

(73) Assignee: COATEX, Genay (FR)

(21) Appl. No.: 15/120,068

(22) PCT Filed: Feb. 12, 2015
(86) PCT No.: PCT/FR2015/050345

§ 371 Date: Aug. 18, 2016

(30) Foreign Application Priority Data
Feb. 21, 2014 (FR) 1451377

(51) Int. Cl. C09C 1/02; C09C 1/30; C08K 3/26

(52) U.S. Cl. CPC C09C 1/021; C08K 3/26; C09C 1/3072; C09C 1/3018; C09C 1/309; C08K 2003/265

(57) ABSTRACT

The present invention relates to the use of copolymers obtained by polymerization of maleic anhydride and of styrene, for preparing particles of mineral matter having a weight-loss start temperature greater than or equal to 220° C., as measured by thermogravimetric analysis (TGA) between 150° C. and 600° C.

### FIELD OF THE INVENTION

The present invention relates to the use of copolymers obtained by polymerization of maleic anhydride and of styrene, functionalized or not, for preparing particles of mineral matter which have a weight-loss onset temperature loss that is as high as possible, as measured by thermogravimetric analysis (TGA). Such particles are particularly advantageous as inorganic fillers in a variety of applications and especially in thermoplastic compositions (for example thermoplastic films), the preparation processes of which use high temperatures.

### BACKGROUND OF THE INVENTION

Mineral matters are used in many applications. For example, calcium carbonate is among the most widely used and least expensive mineral matters. It thus constitutes a filler or pigment of choice commonly used in the plastics, paints or paper industries.

Mineral matters must be treated before they can be used. For example, they must be ground into particles of finer and/or more homogeneous size. There are two main categories of grinding processes, mainly dry grinding and wet grinding. The processes for grinding mineral matters such as calcium carbonate are known to be very energy-intensive. Solutions directed toward increasing the grinding yields are continually sought. In this perspective, it is generally useful to use grinding additives, known as “grinding aid agents”. These additives, introduced during the step of grinding of these minerals, are used to facilitate the grinding process, to assist the process of reducing the particle sizes and to increase the capacity and efficacy of the grinding process.

The literature describes the use of many additives as grinding aid agents. The choice of the additive varies especially as a function of the type of grinding performed, the grinding efficacy desired, and also the final application of the particles of mineral matters thus obtained. The efficacy of a grinding additive depends on its chemical nature and its physical properties. However, no clear logic connecting the mineral matter to be ground, the grinding process and the grinding additive has been established to date.

The use is known of water-soluble homopolymers and/or copolymers of acrylic and/or methacrylic acid with one or more acrylic, vinyl or allylic monomers as aid agents for grinding mineral particles in aqueous suspension, giving them, by use thereof, particular optical properties (WO 02/49766 A1). The use is also known of polar molecules of rather hydrophilic nature, for instance glycerol alone or mixed with organic or inorganic acids, amines or polyglycerols for the process of dry grinding of calcium carbonate (EP 2 516 556 A1, EP 2 510 059 A1). The use is also known of polyalkylene glycol polymers (EP 2 029 677 A1) and of comb copolymers, which are composed of a main chain, also known as the backbone, and of branched comb macromonomers (EP 2 125 234 A1, EP 2 125 235 A1 and EP 2 129 468 A1) for the dry grinding of calcium carbonate.

The present invention falls within the context of the use of a particular copolymer for treating mineral matters, especially for assisting the grinding thereof, for example calcium carbonate. The copolymer in question results from the polymerization of monomers of maleic anhydride and of at least one other monomer comprising a polymerizable vinyl function, more specifically styrene. Mention is made, for illustrative purposes, of low molecular weight copolymers of maleic anhydride and of styrene and derivatives thereof. Such copolymers and derivatives are commercially available, for example in the range SMA® (Cray Valley) and are described especially in documents EP 1 122 263 A1, U.S. Pat. No. 3,941,808 and EP 1 515 994 A1.

Document EP 0 467 287 A2 describes the use of copolymers of maleic anhydride and of hydrolyzed products of these copolymers for inhibiting scale, dispersing calcium carbonate and as cement and concrete additives.

Document U.S. Pat. No. 4,136,830 describes the use of copolymers of styrene and of maleic anhydride, or a salt thereof, as aid agents for the wet grinding of coal.

Document U.S. Pat. No. 5,811,069, for its part, describes a process for preparing a stabilized suspension of magnesium hydroxide, especially comprising a step of adding a polyelectrolyte which may especially be a magnesium poly(styrene/maleate) compound.

Document EP 0 779 342 A1 describes the use of copolymers of styrene and of maleic anhydride as dispersant agents and/or agents for treating mineral fillers and measurement of the melt flow index of granules of thermoplastic compositions containing them.

None of the documents cited above describes the use of such a copolymer for treating particles of mineral matter in order to increase the weight-loss temperature of said particles measured by ThermoGravimetric Analysis (TGA) between 150° C. and 600° C.

The present invention relates to a use of these copolymers for preparing such particles of mineral matters.

ThermoGravimetric Analysis (TGA) is a method allowing the thermal characterization of materials, in the present case of treated particles of mineral matter.

TGA analysis is particularly useful when it is a matter of analyzing the behavior of certain materials at high temperatures, in the present case between 150° C. and 600° C.

Specifically, such temperatures are used, for example, in processes for preparing thermoplastic compositions. However, at such temperatures, volatile compounds associated with the particles of mineral matter (for example grinding additives or a part thereof) are liable to be vaporized, which may present a certain number of drawbacks.

TGA analysis makes it possible to determine precisely at which temperature this vaporization begins by measuring the weight-loss with respect to the starting weight of the sample. It makes it possible to characterize the resistance of particles of mineral matter to thermal degradation.

TGA analysis is, in point of fact, a technique for monitoring the weight-loss of a sample of product subjected to a range of increasing/incremental temperatures, in the present case between 150° C. and 600° C.

By increasing as much as possible the resistance to thermal degradation of the volatile materials associated with mineral particles (i.e. by increasing the decomposition onset temperature), the harmful effects associated with the volatilization of the compounds in the process for preparing thermoplastic compositions are all the more reduced for the formulator.

In the context of the present invention, the “weight-loss onset temperature” means this temperature when decomposition of the volatile compounds associated with the particles of mineral matter begins. This temperature is between 150° C. and 600° C. Specifically, below 150° C., the possible loss of water (boiling point of water) associated with the particles of mineral matter is measured. Above 600° C., the loss of mineral matter per se (for example the CO₂ of calcium carbonate) is measured.

The TGA thermograms make it possible precisely to determine this mass-loss onset temperature. See FIG. 1.

The inventors realized that the use of particular copolymers makes it possible to prepare particles of mineral matter having a high mass-loss onset temperature, i.e. better resistance to thermal degradation.

Documents EP 2 159 258 A1, EP 2 390 208 A1 and EP 2 390 285 A1 describe the advantage of treating fillers of mineral matters with compounds of aliphatic carboxylic acid type (stearic acid, palmitic acid) or a combination thereof which make it possible especially to increase this volatilization onset temperature.

No prior art document suggests that such a technical characteristic can be associated with the use of the copolymers according to the invention.

### BRIEF DESCRIPTION OF THE INVENTION

The present invention relates to the use of a copolymer of formula (I) below:

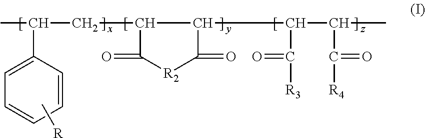

in which:
the units x, y and z are arranged in blocks, alternatively or randomly,
x is non-zero and at least one from among y and z is also non-zero, the sum of x+y+z being less than or equal to 150,
R₁ represents H or a sulfonated group,
R₂ represents a heteroatom, optionally substituted with an alkyl chain, a heteroalkyl chain and/or a polyalkoxylated chain,
R₃ and R₄, independently of each other, represent OH, (O⁻,M⁺), an O-alkyl chain comprising between 1 and 20 carbon atoms, an N-alkyl chain comprising between 1 and 20 carbon atoms and/or a polyalkoxylated chain and
M⁺ represents a monovalent, divalent or trivalent cation,
   for preparing particles of mineral matter having a weight-loss onset temperature that is greater than or equal to 220° C., as measured by ThermoGravimetric Analysis (TGA) between 150° C. and 600° C.

The present invention relates especially to the use of this copolymer for the dry grinding of mineral matter such as to obtain particles of mineral matter having a weight-loss onset temperature that is greater than or equal to 220° C., as measured by ThermoGravimetric Analysis (TGA) between 150° C. and 600° C.

In particular, the present invention relates to the use of this copolymer for the dry grinding of coarse calcium carbonate such as to obtain calcium carbonate particles of finer and/or more homogeneous size having a weight-loss onset temperature that is greater than or equal to 220° C., as measured by ThermoGravimetric Analysis (TGA) between 150° C. and 600° C.

### BRIEF DESCRIPTION OF THE FIGURES

FIG. 1 represents a thermogram obtained by TGA analysis of particles treated according to test 1-7 (invention).

FIG. 2 represents a thermogram obtained by TGA analysis of particles treated according to test 1-2 (prior art).

On these thermograms, the x-axis represents the temperature in ° C. and the y-axis represents the weight (in %).

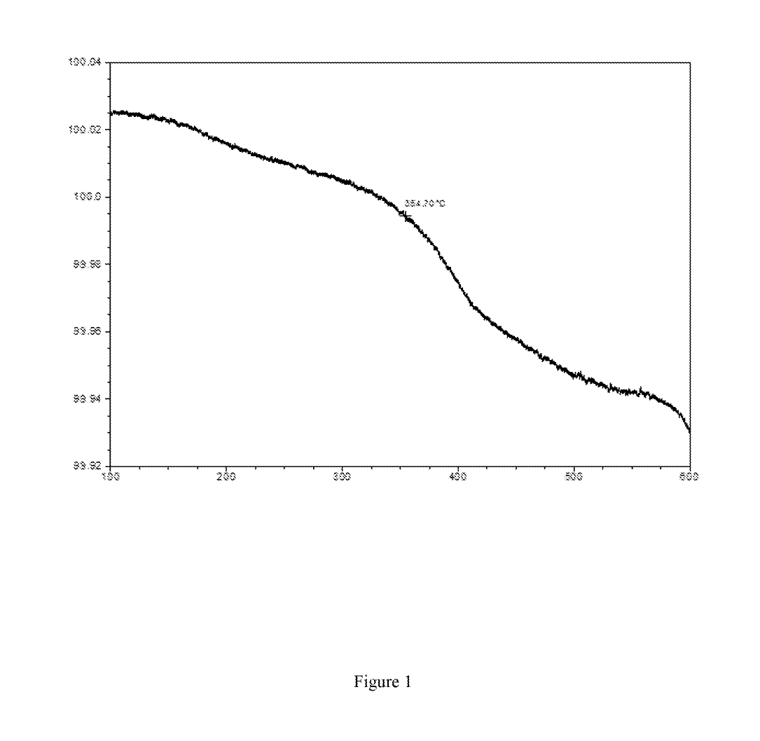

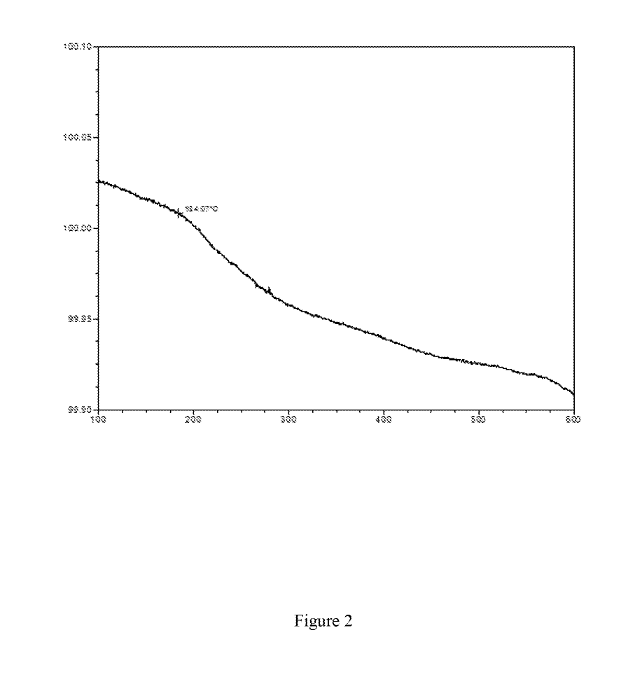

The figures have deliberately been centered on the zone corresponding to the weight-loss onset temperature. For FIG. 1 (representing the invention), the measuring software notes that this weight-loss onset temperature is at 354.7° C. For FIG. 2 (representing the prior art), the measuring software notes that this weight-loss onset temperature is at 184.0° C.

### DETAILED DESCRIPTION OF THE INVENTION

The copolymers under consideration in the present patent application are referred to as copolymers of styrene-maleic anhydride and derivatives, are used during the process for preparing particles of mineral matter, for example during the grinding of mineral matters into particles of homogeneous size and make it possible to obtain particles of mineral matter which have improved thermal stability. More precisely, these particles, prepared using the copolymer of formula (I), have a weight-loss onset temperature that is greater than or equal to 220° C., as measured by TGA analysis between 150° C. and 600° C.

The copolymer under consideration in the context of the present invention results from the polymerization of maleic anhydride monomers and of styrene monomers. Mention is made, as an illustration, of low molecular weight copolymers of maleic anhydride and of styrene and derivatives thereof.

It may be a case of derivatives of these copolymers, for example derivatives of copolymers of maleic anhydride and of styrene containing:
partially or totally hydrolyzed maleic anhydride units and/or
partially or totally esterified maleic anhydride units and/or
partially or totally amidated maleic anhydride units and/or
partially or totally imidated maleic anhydride units and/or
partially or totally sulfonated styrene units.

According to one embodiment, such copolymers have the formula (I) below:

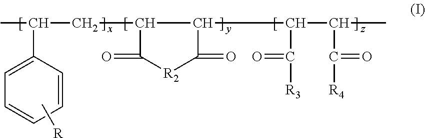

in which:
the units x, y and z are arranged in blocks, alternatively or randomly,
x is non-zero and at least one from among y and z is also non-zero, the sum of x+y+z being less than or equal to 150,
R₁ represents H or a sulfonated group,
R₂ represents a heteroatom, optionally substituted with an alkyl chain, a heteroalkyl chain and/or a polyalkoxylated chain,
R₃ and R₄, independently of each other, represent OH, (O⁻, M⁺), an O-alkyl chain comprising between 1 and 20 carbon atoms, an N-alkyl chain comprising between 1 and 20 carbon atoms and/or a polyalkoxylated chain and
M⁺ represents a monovalent, divalent or trivalent cation.

In the context of the present invention:
the term “sulfonated group” means a group —SO₃H or —(SO₃⁻, M⁺),
the term “heteroatom” means an oxygen, sulfur, nitrogen, silicon or phosphorus atom,
the term “alkyl” means a linear, branched or cyclic, saturated or unsaturated, optionally substituted carbon radical, comprising 1 to 20 carbon atoms,
the term “heteroalkyl” means an alkyl radical as defined previously, said alkyl system comprising at least one heteroatom, chosen especially from the group comprising sulfur, oxygen, nitrogen, phosphorus and silicon and
the term “polyalkoxylated chain” means a chain of the type [(EO)ₙ(PO)_{n′}(BO)_{n″}]—Z, constituted of alkoxylated units, arranged in blocks, alternatively or randomly chosen from ethoxylated units EO, propoxylated units PO and butoxylated units BO, n, n′ and n″ representing, independently of each other, 0 or an integer ranging from 1 to 150, the sum of n, n′ and n″ not being zero and Z represents an alkyl chain comprising between 1 and 20 carbon atoms, for example 1 or 2 carbon atoms.

The copolymers according to the invention are obtained by polymerization of at least two different monomers, according to known and described processes.

The units x in formula (I) are derived from polymerizable monomers of styrene type, optionally modified before or after polymerization. The units x may especially be subjected to a total or partial sulfonation, after polymerization. Thus, the copolymer according to the invention may comprise styrene units per se and/or styrene units substituted with a sulfonated group.

The units y and z, for their part, are derived from maleic anhydride monomers, optionally modified before or after polymerization.

According to one embodiment of the present invention, the copolymer is constituted of units x and of units y.

According to another embodiment of the present invention, the copolymer is constituted of units x and of units z.

According to yet another embodiment, the copolymer is constituted of units x, of units y and of units z.

Finally, according to one embodiment of the present invention, the copolymer is constituted of units x of styrene type, and also of units x of sulfonated styrene type and of units y and z.

The mole ratio between the units x, on the one hand, and the units y and/or z, on the other hand, in the copolymer may range between 10:1 and 1:2. For example, the mole ratio between the units x, on the one hand, and the units y and/or z, on the other hand, in the copolymer is 1:1, 2:1 or 3:1.

Said copolymers or derivatives used in the context of the present invention are in acid form or in neutralized form.

When they are neutralized, the copolymers according to the invention are totally or partially neutralized.

In formula (I) above, or in formula (III) below, M⁺ is chosen, for example, from calcium (Ca²⁺), magnesium (Mg²⁺), lithium (Li⁺), sodium (Na⁺), potassium (K⁺) and ammonium (NH₄⁺). M⁺ may also be an ammonium. In this case, the neutralization is preferably partial.

The use of such copolymers makes it possible to prepare calcium carbonate particles that have improved thermal stability. Specifically, the weight-loss onset temperature is greater than or equal to 220° C., as measured by ThermoGravimetric Analysis (TGA) between 150° C. and 600° C.

This has many advantages. The particles have better thermal stability, which makes it possible to limit the vaporization of the volatile compounds during the rise in temperature of the constituents of the thermoplastic compositions, for the purpose of forming them.

According to one embodiment, said weight-loss onset temperature of said particles of mineral matter is greater than or equal to 250° C.

According to one embodiment of the present invention, to prepare particles of mineral matter having a weight-loss onset temperature that is greater than or equal to 220° C., as measured by ThermoGravimetric Analysis (TGA) between 150° C. and 600° C., a copolymer of formula (II) below is used:

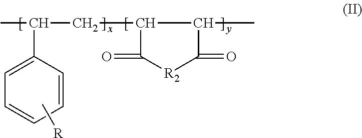

in which:
the units x and y are arranged in blocks, alternatively or randomly,
x and y are non-zero, the sum of x+y being less than or equal to 150,
R₁ represents H or a sulfonated group and
R₂ represents a heteroatom, optionally substituted with an alkyl chain, a heteroalkyl chain and/or a polyalkoxylated chain.

According to another embodiment, to prepare particles of mineral matter having a weight-loss onset temperature that is greater than or equal to 220° C., as measured by ThermoGravimetric Analysis (TGA) between 150° C. and 600° C., a copolymer of formula (III) below is used:

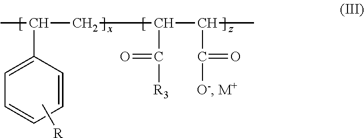

in which:
the units x and z are arranged in blocks, alternatively or randomly,
x and z are non-zero, the sum of x+z being less than or equal to 150,
R₁ represents H or a sulfonated group,
R₃ represents OH, (O⁻, M⁺), an O-alkyl chain comprising between 1 and 20 carbon atoms, an N-alkyl chain comprising between 1 and 20 carbon atoms and/or a polyalkoxylated chain and
M⁺ represents a monovalent, divalent or trivalent cation.

According to another embodiment, to prepare particles of mineral matter having a weight-loss onset temperature that is greater than or equal to 220° C., as measured by ThermoGravimetric Analysis (TGA) between 150° C. and 600° C., a copolymer of formula (I) is used in which x, y and z are non-zero and less than 150, the units x, y and z being arranged in blocks, alternatively or randomly.

Throughout the present description, the group R₂ represents a heteroatom, optionally substituted with an alkyl chain, a heteroalkyl chain and/or a polyalkoxylated chain.

According to one embodiment, the group R₂ represents an O atom.

According to another embodiment, the group R₂ represents an N atom substituted with an alkyl chain, a heteroalkyl chain and/or a polyalkoxylated chain. The N atom may especially be substituted with an alkyl chain having a primary, secondary or tertiary ammonium function.

By way of example, the group R₂ represents N—CH₂—CH₂—N(CH₃)₂.

Throughout the present description, the groups R₃ and R₄, independently of each other, represent OH, (O⁻, M⁺), an O-alkyl chain comprising between 1 and 20 carbon atoms, an N-alkyl chain comprising between 1 and 20 carbon atoms and/or a polyalkoxylated chain.

According to one embodiment, the groups R₃ and R₄ represent (O⁻, M⁺), for example (O⁻, NH₄⁺).

According to another embodiment, the groups R₃ and R₄ represent, for one, OH, and, for the other, an O-alkyl chain comprising between 1 and 20 carbon atoms.

According to yet another embodiment, the groups R₃ and R₄ represent (O⁻, M⁺), for example (O⁻, NH₄⁺), and, for the other, an O-alkyl chain comprising between 1 and 20 carbon atoms.

According to another embodiment, the copolymer is such that it comprises two different types of units z. According to this embodiment, a part of the units z of the copolymer according to the invention is such that the groups R₃ and R₄ represent (O⁻, M⁺), for example (O⁻, NH₄⁺). Another part of the units z of the copolymer is such that the groups R₃ and R₄ represent, for one, (O⁻, M⁺), for example (O⁻, NH₄⁺) and, for the other, an O-alkyl chain comprising between 1 and 20 carbon atoms.

According to yet another embodiment, the groups R₃ and R₄ represent, for one, (O⁻, M⁺), for example (O⁻, NH₄⁺) and, for the other, a polyalkoxylated chain, for example —C₄H₈—O—CH₂—CH₃.

According to one embodiment, the copolymer according to the invention is in solution form, in powder form, in resin form or in flakes form.

In the context of the present invention, said copolymer is used for preparing particles of mineral matter. The term “preparing” should be understood herein in its largest definition. The preparation of particles of mineral matter may comprise steps of placing in contact and/or grinding and/or dispersing and/or classifying and/or drying and/or concentrating. The copolymer according to the invention may be used, for example, during one of these steps. The preparation step, i.e. the step of placing in contact and/or grinding and/or dispersing and/or classifying and/or drying and/or concentrating, may take place at room temperature, in the presence of a cooling system, or at a temperature between room temperature and 200° C.

The copolymers according to the invention may be used as co-grinding additives for grinding mineral particles in aqueous suspension. Such grinding requires the use of a large content of water relative to the dry weight of material to be ground.

In contrast to these grinding aid agents that may be used in a humid environment, the copolymers according to the invention may also be used for grinding such mineral matters in dry medium.

According to one embodiment, said particles of mineral matter are obtained by dry grinding in the presence of said copolymer.

Dry grinding is generally performed in a grinder and results from an autogenous grinding operation, in which the particles to be ground undergo impacts with each other, or result from additional impacts with one or more other materials such as grinding beads. Such grinding may take place, for example, in a ball mill, a vibration mill or a wheel mill. Depending on the type of grinding, said grinding may take place in a stationary or rotary grinding chamber. The dry-grinding agents may be added to the feed and/or into the grinding chamber and/or during the grinding process.

According to another embodiment, said particles of mineral matter are obtained by wet grinding in the presence of said copolymer.

According to one embodiment, said particles of mineral matter are obtained by placing the particles of mineral matter in contact with said copolymer.

The placing in contact of the particles of mineral matter with said copolymer according to the invention is likely to make the surface of the particles more hydrophobic and then leads to surface-treated particles. The particles resulting therefrom may then be used as fillers in a variety of applications, for example in thermoplastic compositions. Such a surface treatment of the particles is especially likely to solve the problem of dispersibility with the hydrophobic polymers (PP and PE, for example) constituting the thermoplastic compositions.

In this embodiment of the present invention, the placing of the particles of mineral matter in contact with said copolymer is performed, for example, by mixing the particles with said copolymer. The term “mixing” means any conventional mixing process known to the person skilled in the art. The mixing is preferably performed with continuous stirring so that all of the particles of mineral matter are equally placed in contact with said copolymer.

The placing in contact of the particles and of said copolymer may take place at room temperature or at a temperature above room temperature.

For example, the placing in contact may take place at an adjusted temperature, so that said copolymer is in liquid or molten form. The temperature at which the particles are placed in contact with said copolymer according to the invention may result from shear of the mixing device used or, alternatively, from an external source or else from a combination of the two.

According to one embodiment, during the preparation of the particles of mineral matter, the copolymer is present in an amount of from 0.01% to 10% by weight, on the basis of the total weight of the mineral matters, for example from 0.05% to 5% by weight, from 0.08% to 3.0% by weight, from 0.09% to 2.0% by weight or from 0.1% to 1.5% by weight.

TGA analysis is a technique for monitoring the weight-loss of a sample of products subjected to a range of increasing/incremental temperatures, in the present case between 150° C. and 600° C. The technique is described especially in Principles of Instrumental Analysis, 5^{th} Edition, Skoog, Holler, Nieman, 1998 (1^{st} Edition 1992), Chapter 31, pages 798-800.

In the context of the present invention, the “weight-loss onset temperature” refers to this temperature at which the decomposition of the volatile compounds associated with the particles of mineral matter begins. This temperature is between 150° C. and 600° C. Specifically, below 150° C., the possible loss of water (boiling point of water) associated with the particles of mineral matter is measured. Above 600° C., the loss of mineral matter per se (for example calcium carbonate) is measured.

The TGA thermograms make it possible to determine precisely this mass-loss onset temperature. The person skilled in the art knows how to determine the weight-loss onset temperature from the thermograms and suitable software. This temperature corresponds to the second derivative peak of the curve which corresponds to the 1st point of inflection, measured between 150 and 600° C.

The thermogravimetric measurement may be performed with a Q500 apparatus from TA INSTRUMENTS. It may also be performed, for example, on an apparatus such as the Mettler Toledo TGA 851.

The term “mineral matter” means a mineral matter chosen from the group consisting of natural calcium carbonate, synthetic calcium carbonate, dolomites, kaolin, talc, gypsum, lime, magnesia, titanium dioxide, satin white, aluminum trioxide, aluminum trihydroxide, silica, mica and a mixture of these fillers.

According to one embodiment, said copolymer is obtained by polymerization of maleic anhydride and of styrene, followed by neutralization.

According to one embodiment, said copolymer is in a form partially or totally neutralized with sodium and/or ammonium.

According to one embodiment of the present invention, said copolymer is such that, in formula (I):
R₁ represents —(SO₃⁺, Na⁺),
y is equal to 0 and
R₃ and R₄ represent (O⁻, Na⁺).

Thus, such a copolymer is constituted exclusively of units x and z, i.e. of sulfonated styrene and of maleic anhydride. The mole ratio between the units x and the units z in the copolymer may range between 10:1 and 1:2. For example, the mole ratio between the units x and the units z in the copolymer is 1:1, 2:1 or 3:1.

According to one embodiment of the present invention, said copolymer is such that, in formula (I):
R₁ represents H,
y is equal to 0 and
R₃ and R₄ represent (O⁻, NH₄⁺).

Thus, such a copolymer is constituted exclusively of units x and z, i.e. of styrene and of maleic anhydride. The mole ratio between the units x and the units z in the copolymer may range between 10:1 and 1:2. For example, the mole ratio between the units x and the units z in the copolymer is 1:1, 2:1 or 3:1.

According to one embodiment of the present invention, the copolymers have a molecular weight of less than 20,000 g/mol, for example less than 15,000 g/mol or 12,000 g/mol.

According to one embodiment of the present invention, the copolymers have a molecular mass of greater than 500 g/mol, for example greater than 1,000 g/mol.

The molecular weight of the copolymers according to the invention is determined by Gel Permeation Chromatography (GPC).

Such a technique uses a WATERS™ brand liquid chromatography apparatus equipped with a detector. This detector is a WATERS™ brand refractometric concentration detector.

This liquid chromatography apparatus is equipped with a steric exclusion column suitably chosen by the person skilled in the art so as to separate the various molecular weights of the polymers studied.

The liquid elution phase is an aqueous phase adjusted to pH 9.00 with IN sodium hydroxide containing 0.05M of NaHCO₃, 0.1M of NaNO₃, 0.02M of triethanolamine and 0.03% of NaN₃.

In a detailed manner, according to a first step, the copolymer is diluted to 0.9% dry in the solubilization solvent of the SEC, which corresponds to the liquid elution phase for the SEC, to which is added 0.04% of dimethylformamide which acts as flow marker or internal standard. Then, the mixture is filtered through a 0.2 m filter. 100 μL are then injected into the chromatography apparatus (eluent: an aqueous phase adjusted to pH 9.00 with IN sodium hydroxide containing 0.05M of NaHCO₃, 0.1M of NaNO₃, 0.02M of triethanolamine and 0.03% of NaN₃).

The liquid chromatography apparatus contains an isocratic pump (WATERS™ 515) whose flow rate is set at 0.8 ml/min. The chromatography apparatus also comprises an oven, which itself comprises in series the following system of columns: a GUARD COLUMN ULTRAHYDROGEL WATERS™ precolumn of 6 cm long and of inside diameter 40 mm and a ULTRAHYDROGEL WATERS™ linear column of 30 cm long and of inside diameter 7.8 mm. The detection system is itself composed of a RI WATERS™ 410 refractometric detector. The oven is brought to a temperature of 60° C. and the refractometer is brought to a temperature of 45° C.

The chromatography apparatus is calibrated with sodium polyacrylate powder standards of different molecular masses certified by the supplier: POLYMER STANDARD SERVICE or AMERICAN POLYMER STANDARDS CORPORATION.

The particles of mineral matter prepared using a copolymer according to the invention are likely to have a susceptibility to moisture absorption of less than or equal to 1.5 mg/g, for example less than or equal to 1.4 mg/g. This value corresponds to the amount of moisture absorbed at the surface of the particles of mineral matter. It is evaluated in mg of moisture per g of particles of mineral matter treated, after exposure to an atmosphere of 10% relative humidity and then 85% relative humidity for 2.5 hours at a temperature of 23° C. (±2° C.). It is sought to minimize this value at the maximum of susceptibility to moisture absorption, in particular when the particles are intended to be used as fillers in thermoplastic formulations. The particles of mineral matter are indeed likely to absorb moisture during their storage, transportation and/or “processing”. This moisture absorbed onto the particles may then lead to void zones in the thermoplastic formulations produced via processes involving a high temperature.

The present invention also relates to the use of a styrene-maleic anhydride copolymer, or a derivative thereof, for reducing the susceptibility of mineral matters to moisture absorption, said mineral matters being dry-ground in the presence of said copolymer or derivative.

The present invention also relates to the use of a copolymer of styrene and of maleic anhydride, or a derivative thereof, for increasing the decomposition-onset temperature of volatile materials, measured by ThermoGravimetric Analysis (TGA), of mineral matters ground in the presence of said copolymer or derivative.

The examples that follow make it possible to understand the present invention better, without limiting its scope.

### EXAMPLES

The examples below illustrate the preparation of particles of mineral matter with a weight-loss onset temperature of greater than or equal to 220° C. Measurements of thermal degradation resistance and of susceptibility to moisture absorption are carried out on these particles according to the following protocols.

### Resistance to Thermal Degradation by TGA

To begin with, the particles of mineral matter are dried if they are in suspension. They are reduced to powder form using a spatula and then a mortar.

The thermogravimetric measurement is carried out with a Q500 apparatus from TA INSTRUMENTS.

The mass-loss is determined by the dynamic high resolution technique. The following parameters are set: temperature increase ramp of 20° C./min from 150° C. to 600° C. The weights of samples used are 30 mg±10 mg.

The change in the percentage of remaining mass of the sample (relative to its initial mass) as a function of the temperature is then recorded. A thermogram according to FIG. 1, for example, is obtained.

### Susceptibility to Moisture Absorption

This is the amount of moisture absorbed at the surface of the particles of mineral matter. It is evaluated in mg of moisture per g of particles of mineral matter treated, after exposure to an atmosphere of 10% relative humidity and then 85% relative humidity for 2.5 hours at a temperature of 23° C. (±2° C.). More precisely, the treated particles are first exposed to an atmosphere at 10% relative humidity, then to an atmosphere of 85% relative humidity, at which the sample is maintained for 2.5 hours. The weight increase between 10% and 85% relative humidity is used to calculate the susceptibility to moisture absorption in mg/g.

### Example 1

This example illustrates the use of various additives for preparing calcium carbonate particles by dry grinding.

The additive to be tested is added in a proportion of 1,000 ppm (i.e. 0.1% by weight) to a coarse calcium carbonate originating from Italy, having an average diameter of about 1 mm.

The calcium carbonate thus treated is introduced into a 4 liter ball mill containing 5,840 g of steel grinding balls of 15 mm by 15 mm Cylpebs type.

The amount of calcium carbonate is 1,200 g. The grinding time is 150 minutes.

Test 1-1: the additive used is monopropylene glycol (MPG).

Test 1-2: the additive used is a mixture of 75% by weight of glycerol and 25% by weight of TIPA (glycerol/TIPA).

Test 1-3: the additive used is a copolymer of styrene and of maleic anhydride (S:MA mole ratio=1:1) of molecular weight 5,000 g/mol and neutralized with NaOH to pH=10 (dry solids content of 30% by weight).

Test 1-4: the additive used is a copolymer of styrene and of maleic anhydride (S:MA mole ratio=2:1) of molecular weight 7,500 g/mol and neutralized with NaOH to pH=10 (dry solids content of 28% by weight).

Test 1-5: the additive used is a copolymer of styrene and of maleic anhydride (S:MA mole ratio=3:1) of molecular weight 10,000 g/mol and neutralized with NaOH to pH=10.2 (dry solids content of 28% by weight).

Test 1-6: the additive used is a copolymer of styrene and of maleic anhydride (S:MA mole ratio=1:1) of butanol and ethanol ester type (base anhydride of SMA® 1440H) of molecular weight 5,000 g/mol and neutralized with NaOH to pH=10.1 (dry solids content of 25% by weight).

Test 1-7: the additive used is a copolymer of styrene and of maleic anhydride (S:MA mole ratio=2:1) of butanol and hexanol ester type (SMA® 2625H) of molecular weight 7,500 g/mol and neutralized with NH₄OH to pH=10 (dry solids content of 27% by weight).

Test 1-8: the additive used is a copolymer of sulfonated styrene units, of styrene units and of maleic anhydride units (S:MA mole ratio=1:1) of molecular weight 5,000 g/mol and neutralized with NaOH to pH=10 (dry solids content of 30% by weight).

The carbonate particles thus obtained are characterized by TGA analysis and measurement of the susceptibility to moisture absorption, according to the abovementioned protocols. All the results are given in table 1 below:

TABLE 1

| | Prior | | T ° C. | Susceptibility |
|---|---|---|---|---|
| | Art/ | | weight-loss | to moisture |
| | INVen- | | onset (TGA | absorption |
| Test | tion | Grinding additive | analysis) | (mg/g) |
| 1-1 | PA | MPG | 197 | 1.6 |
| 1-2 | PA | Glycerol + TIPA | 183 | 2.2 |
| 1-3 | INV | SMA (S:MA = 1:1) | 379 | 1.3 |
| | | 5,000 g/mol, Na⁺ | | |
| 1-4 | INV | SMA (S:MA = 2:1) | 379 | 1.4 |
| | | 7,500 g/mol, Na⁺ | | |
| 1-5 | INV | SMA (S:MA = 3:1) | 356′ | 1.3 |
| | | 10,000 g/mol, Na⁺ | | |
| 1-6 | INV | SMA derivative (S:MA = | 387 | 1.0 |
| | | 1:1), 5,000 g/mol, Na⁺ | | |
| 1-7 | INV | SMA derivative (S:MA = | 355 | 1.0 |
| | | 2:1), 7,500 g/mol, NH₄⁺ | | |
| 1-8 | INV | Sulfonated derivative of | 390 | 1.4 |
| | | SMA (S:MA = 1:1), | | |
| | | 5,000 g/mol, Na⁺ | | |

All the additives of styrene-maleic anhydride type or derivatives (tests 1-3 to 1-8) make it possible to obtain calcium carbonate particles with a weight-loss onset temperature very much higher than that obtained with calcium carbonate particles ground in the presence of monopropylene glycol (MPG) or of a mixture of 75% of glycerol and 25% of TIPA (Glycerol/TIPA).

It is moreover noted that the additives of styrene-maleic anhydride type or derivatives used as dry grinding additives (tests 3 to 8) for calcium carbonate make it possible to reduce the susceptibility to moisture absorption of said particles to a value of less than 1.5 mg of water per g of mineral matter.

See also FIGS. 1 and 2 showing the thermograms obtained, respectively, with tests 1-7 and 1-2.

### Example 2

The tests performed relate to the use of various additives for preparing calcium carbonate particles by wet grinding.

Various aqueous suspensions of ground calcium carbonate (GCC, marble originating from Italy), each having a solids content of 50±1%, are prepared by grinding in the presence of 0.2% by dry weight of an additive to be tested calculated relative to the dry calcium carbonate.

The suspensions of coarse calcium carbonate are introduced into a DYNO MILL 1.4 L KDL pilot mill containing 2,100 g of grinding beads (Ø 1 to 1.6 mm).

The grinding is continued until a suspension is obtained in which about 45% by weight of the particles have an equivalent spherical diameter of less than 2 μm.

Test 2-1: the additive used is a neutralized sodium/calcium polyacrylic acid (PAA⁻, 70% Na⁺, 30% Ca²⁺; Mw=5,700 g/mol).

Test 2-2: the additive used is a copolymer of styrene and of maleic anhydride (S:MA mole ratio=1:1) of butanol and ethanol ester type (base anhydride of SMA® 1440H) of molecular weight 5,000 g/mol and neutralized with NaOH to pH=10.1 (dry solids content of 25% by weight).

Test 2-3: the additive used is a copolymer of styrene and of maleic anhydride (S:MA mole ratio=2:1) of butanol and hexanol ester type (SMA® 2625H) of molecular weight 7,500 g/mol and neutralized with NH₄OH to pH=10 (dry solids content of 27% by weight).

Test 2-4: the additive used is a copolymer of sulfonated styrene units, of styrene units and of maleic anhydride units (S:MA mole ratio=1:1) of molecular weight 5,000 g/mol and neutralized with NaOH to pH=10 (dry solids content of 30% by weight).

The carbonate particles thus obtained are characterized by TGA analysis and measurement of the susceptibility to moisture absorption according to the abovementioned protocols. All the results are given in table 2 below:

TABLE 2

| | Prior | | T ° C. | Susceptibility |
|---|---|---|---|---|
| | Art/ | | weight-loss | to moisture |
| | INVen- | | onset (TGA | absorption |
| Test | tion | Grinding additive | analysis) | (mg/g) |
| 2-1 | PA | PAA⁻, Na⁺/Ca²⁺ | 354 | 5.3 |
| 2-2 | INV | SMA derivative (S:MA = | 370 | 2.6 |
| | | 1:1), 5000 g/mol, Na⁺ | | |
| 2-3 | INV | SMA derivative (S:MA = | 373 | 2.7 |
| | | 2:1), 7500 g/mol, NH₄⁺ | | |
| 2-4 | INV | Sulfonated derivative of | 378 | 4.6 |
| | | SMA (S:MA = 1:1), | | |
| | | 5000 g/mol, Na⁺ | | |

All the additives of styrene-maleic anhydride type or derivatives (tests 2-2 to 2-4) make it possible to obtain calcium carbonate particles with a weight-loss onset temperature that is very much greater than that obtained with calcium carbonate particles ground in the presence of a sodium-neutralized polyacrylic acid (PAA⁻, Na⁺/Ca²⁺; Mw=5,700 g/mol).

1-10. (canceled)

11: A method for preparing particles of a mineral matter, the method comprising:
treating the particles with a copolymer of formula (I): 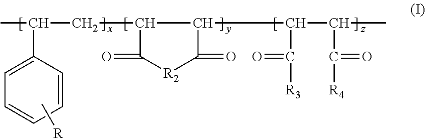
where:
units x, y, and z are arranged in alternative or random blocks,
x is non-zero, at least one of y and z is non-zero, a sum of x+y+z is less than or equal to 150,
R₁ represents H or a sulfonated group,
R₂ represents a heteroatom, optionally substituted with an alkyl chain, a heteroalkyl chain, and/or a polyalkoxylated chain,
R₃ and R₄ each independently represent OH, (O⁻,M⁺), an O-alkyl chain comprising from 1 to 20 carbon atoms, an N-alkyl chain comprising from 1 to 20 carbon atoms, and/or a polyalkoxylated chain, and
M⁺ represents a monovalent, divalent, or trivalent cation,
wherein the particles have a weight-loss onset temperature of greater than or equal to 220° C., as measured by ThermoGravimetric Analysis (TGA) between 150° C. and 600° C.

12: The method of claim 1, wherein said treating comprises dry grinding the particles in the presence of the copolymer.

13: The method of claim 1, wherein the copolymer satisfies formula 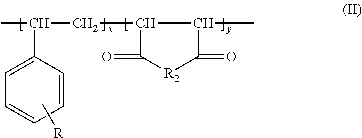
where:
the units x and y are arranged in alternative or random blocks,
x and y are non-zero, a sum of x+y is less than or equal to 150,
R₁ represents H or a sulfonated group, and
R₂ represents a heteroatom, optionally substituted with an alkyl chain, a heteroalkyl chain, and/or a polyalkoxylated chain.

14: The method of claim 1, wherein the copolymer satisfies formula (III): 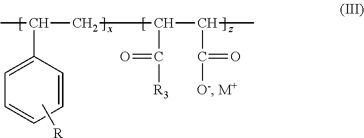
where:
the units x and z are arranged in alternative or random blocks,
x and z are non-zero, a sum of x+z is less than or equal to 150,
R₁ represents H or a sulfonated group,
R₃ represents OH, (O⁻,M⁺), an O-alkyl chain comprising from 1 to 20 carbon atoms, an N-alkyl chain comprising from 1 to 20 carbon atoms, and/or a polyalkoxylated chain, and
M⁺ represents a monovalent, divalent, or trivalent cation.

15: The method of claim 1, wherein the mineral matter is selected from the group consisting of natural calcium carbonate, synthetic calcium carbonate, a dolomite, kaolin, talc, gypsum, lime, magnesia, titanium dioxide, satin white, aluminum trioxide, aluminum trihydroxide, silica, mica, and a mixture thereof.

16: The method of claim 1, wherein the copolymer is obtained by a process comprising:
polymerizing maleic anhydride and styrene in a reaction mixture, and
subsequently neutralizing the reaction mixture.

17: The method of claim 1, wherein the copolymer is in a form partially or totally neutralized with sodium and/or ammonium.

18: The method of claim 1, wherein
R₁ represents —(SO₃⁻, Na⁺),
y is 0, and
R₃ and R₄ represent (O⁻, Na⁺).

19: The method of claim 1, wherein the weight-loss onset temperature of the particles is greater than or equal to 250° C.

20: The method of claim 1, wherein the particles have a susceptibility to moisture absorption of less than or equal to 1.5 mg/g.
